(19) United States
(12) Patent Application Publication
(10) Pub. No.: US 2008/0187640 A1
(43) Pub. Date: Aug. 7, 2008

(54) Nutritional meal replacement high-protein bar, method of making the bar and improving the flavor and texture thereof

(76) Inventor: John H. Owoc, Davie, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/703,307

(22) Filed: Feb. 7, 2007

(51) Int. Cl. C11B 5/00

(52) U.S. Cl. 426/541

(57) ABSTRACT

A nutritional and/or meal replacement high-protein bar and method for making the bar and improving the flavor and texture thereof. The high-protein bar of the present invention is of a composition made up of various ingredients that, in suitable proportions, delivers the requisite amount of protein to the body that is needed for energy, muscle development, and endurance, while imparting a delicious taste and texture.

### CROSS-REFERENCE TO RELATED APPLICATION

n/a

### STATEMENT REGARDING FEDERALLY SPONSORED RESEARCH OR DEVELOPMENT

n/a

### BACKGROUND OF THE INVENTION

1. Field of the Invention

The invention lies in the field of nutritional food bars. The invention specifically relates to a nutritional and/or meal replacement high-protein bar and a method for making the bar and improving the flavor and texture thereof.

2. Description of the Related Art

High-proteins bars, sports bars, nutrition bars or meal replacement bars are commercialized in the nutritional industry to supplement the levels of protein required for energy, muscle development, recovery and preserving and endurance.

Nutritional bars containing high levels of proteins suffer from two major disadvantages. One important disadvantage is that nutritional bars containing high levels of whey protein have a tendency to harden to an unacceptable texture after a short period of time. Hardness is measured in the industry as a g-force and can increase in such bars from 100 g-force to 17000 g-force in a matter of months.

The other important draw back of nutritional bars is poor taste and texture. Many sports bars are barely palatable; and their texture range from plastic-like, un-chewable pieces to hard-to-bite masses.

Bar manufacturers have addressed these two issues by adding to their bars large amounts of Maltitol Syrups (20-40%) and large quantities of chocolate or carob, whether melted or as chocolate chips or drops. High amounts of Maltitol syrups are known to produce a severe laxative effect and high amounts of chocolate bring undesirable levels of sugars and calories to the bars. Thus, such “remedies” adversely affect the desired characteristics of the bar instead of improve then.

Consumer awareness has grown to the point where taste and texture are in the forefront. In addition, consumers are conscious of the consequences of ingesting unnecessary amounts of sugars. Therefore, there is a need to develop a technologically sound, high-protein content bar that fulfills the energy supplement requirements of the athlete while at the same time possesses a palatable taste and a soft chewable texture with a visual and sensory appeal.

### SUMMARY OF THE INVENTION

It is accordingly an object of the invention to provide a nutritional and/or meal replacement high-protein bar and a method for making the bar and improving the flavor and texture thereof that overcome the hereinafore-mentioned disadvantages of the heretofore-known devices and methods of this general type and that that fulfills the energy supplement requirements of the athlete while, at the same time, possesses a palatable taste and a soft chewable texture with a visual and sensory appeal that does not substantially harden over the shelf-life of the product.

The present invention relates to a composition or compositions containing various ingredients used in the preparation of a high-protein bar that, when combined in suitable proportions to deliver the required amount of protein for energy, muscle development, and endurance, imparts a palatable taste and texture to the bar and keeps soft over the shelf-life of the product.

An advantage of the compositions of the present invention is that it extends the shelf-life of the bars. The bars produced contain a soft-extruded core that will maintain its soft texture across the product's shelf life. The hardness is maintained over the expected shelf life of the bars.

Other features that are considered as characteristic for the invention are set forth in the appended claims.

Although the invention is illustrated and described herein as embodied in a nutritional and/or meal replacement high-protein bar and a method for making the bar and improving the flavor and texture thereof, it is, nevertheless, not intended to be limited to the details described because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments.

### DESCRIPTION OF THE PREFERRED EMBODIMENTS

While the specification concludes with claims defining the features of the invention that are regarded as novel, it is believed that the invention will be better understood from a consideration of the following description.

Purees are liquid suspension of vegetables. Purees can be prepared from a vast number of vegetables. Pumpkin and yam purees, in particular, posses a soft, moist, and pasty consistency.

Pumpkin puree and sweet potato (yam) purees are used in the confectionary industry for the preparation of pies, cakes and other pastries. They are also eaten whole in regular meals. These purees are known for their high content of various vitamins and minerals.

The most common source of protein in high-protein bars is whey protein. Most whey ingredients are derived from sweet whey. Sweet whey is, then, spray-dried and, through the use of ultrafiltration and microfiltration, the proteins in whey are concentrated to make high-protein ingredients. Whey protein is commercialized as Whey Protein Concentrate (34 to 80% protein) or as Whey Protein Isolate (80 to 90% protein). These ingredients occur as free-flowing, white to tan colored powders that can be admixed with other ingredients in the preparation of protein bars, cookies, and other bakery products.

The present invention comprises a composition of mixtures of whey protein isolates, whey protein concentrates, milk protein isolates, soy protein concentrates, soy protein isolates, and any other protein isolate or concentrate admixed in suitable proportions with pumpkin, sweet potato, or yam purees or with any other vegetable puree to produce high-protein bars possessing a highly palatable taste and a soft, moist texture.

The composition may include other ingredients such as natural or artificial sweeteners in liquid or powder form, syrups, polyols, flavors, honey, salt, cinnamon, unsweetened chocolate in small quantities, preservatives, natural and synthetic gums, bulking agents such as glycerin, propylene glycol, natural surfactants and antioxidants such as lecithin and stearates, vitamin E, tocopherols, etc. Other components that can enhance the nutritional profile of the bars may also be included, such as oats, peanut butter, almond butter, sunflower butter, unsaturated fats, peanuts, raisins, etc.

The following examples illustrate typical bar compositions:

The following chart is an example bar composition for a peanut/chocolate bar.

PEANUT/CHOCOLATE BAR

| | Percentages Range |
|---|---|
| Milk Protein Isolate | 10–25% |
| Salt | 0.01–0.50% |
| Oats | 0.5–20% |
| Pumpkin puree | 0.5–15% |
| Yam puree | 0.5–15% |
| Peanut Oil | 1–45% |
| Lecithin | 0.01–2% |
| Water | 10–50% |
| Tocopherols | 0.01–1.0% |
| Xanthan Gum | 0.001–5% |
| Potassium Sorbate | 0.005–0.20% |
| Glycerin | 0.5–15% |
| Xylitol Solution | 0.5–5% |
| Propylene Glycol | 0.5–20% |
| Semisweet Chocolate Chips | 0.5–5% |

The following chart is an example bar composition for an almond/sunflower bar.

ALMOND/SUNFLOWER BAR

| | Percentages Range |
|---|---|
| Whey Protein Isolate | 5–40% |
| Salt | 0.01–0.50% |
| Cinnamon | 0.01–1% |
| Oats | 0.5–20% |
| Potassium Sorbate | 0.005–0.20% |
| Pumpkin puree | 0.5–15% |
| Water | 10–50% |
| Sweet Potato puree | 0.5–15% |
| Almond Oil | 1–45% |
| Sunflower oil | 1–45% |
| Semisweet Chocolate | 1–10% |
| Lecithin | 0.01–2% |
| Vitamin E | 0.01–0.5% |
| Glycerin | 0.5–15% |
| Propylene Glycol | 0.5–20% |

While the preferred embodiments of the invention have been illustrated and described, it will be clear that the invention is not so limited. Numerous modifications, changes, variations, substitutions, and equivalents will occur to those skilled in the art without departing from the spirit and scope of the present invention as defined by the appended claims.

What is claimed is:

1. A nutritional bar, the bar comprising:
about 10% to about 25% milk protein isolate;
about 0.01 to about 0.50% salt;
about 0.5% to about 20% oats;
about 0.5% to about 15% pumpkin puree;
about 0.5% to about 15% yam puree;
about 1% to about 45% peanut oil;
about 0.01% to about 2% lecithin;
about 10% to about 50% water;
about 0.01% to about 1.0% tocopherols;
about 0.001% to about 5% xanthan gum;
about 0.005% to about 0.20% potassium sorbate;
about 0.5% to about 15% glycerin;
about 0.5% to about 5% xylitol solution;
about 0.5% to about 20% propylene glycol; and
about 0.5% to about 5% semi-sweet chocolate chips.

2. A nutritional bar, the bar comprising:
about 5% to about 40% whey protein isolate;
about 0.01% to about 0.50% salt;
about 0.01% to about 1% cinnamon;
about 0.5% to about 20% oats;
about 0.005% to about 0.20% potassium sorbate;
about 0.5% to about 15% pumpkin puree;
about 10% to about 50% water;
about 0.5% to about 15% sweet potato puree;
about 1% to about 45% almond oil;
about 1% to about 45% sunflower oil;
about 1% to about 10% semisweet chocolate;
about 0.01% to about 2% lecithin;
about 0.01% to about 0.5% vitamin E;
about 0.5% to about 15% glycerin; and
about 0.5% to about 20% propylene glycol.
